(19) United States
(12) Patent Application Publication
(10) Pub. No.: US 2026/0318079 A1
(43) Pub. Date: Oct. 15, 2026

(54) SPACER ASSEMBLY FOR WATER LEAKAGE PREVENTION IN PHOTOVOLTAIC TILE ARRANGEMENT

(71) Applicant: Arka Energy Inc., Allen, TX (US)

(72) Inventors: Giriprasad Vadla, Bengaluru (IN); Praveen Kumar D, Bengaluru (IN); Apheth D Almeida, Bengaluru (IN)

(73) Assignee: Arka Energy Inc., Allen, TX (US)

(21) Appl. No.: 19/177,793

(22) Filed: Apr. 14, 2025

(51) Int. Cl. E04D 1/00; E04D 1/36; H02S 20/25

(52) U.S. Cl. CPC E04D 1/2984; E04D 1/2949; E04D 1/365; H02S 20/25

(57) ABSTRACT

Disclosed is a spacer assembly for water leakage prevention in a photovoltaic tile arrangement. The spacer assembly comprises: an extruded aluminium profile; a first ethylene propylene diene monomer (EPDM) profile; and a second EPDM profile. The extruded aluminium profile comprises: a first part having a first groove and a first projecting lip (PL); a second part having a second groove and a second PL, a space between the first PL and the second PL forming a water flow channel; and a third part extending vertically downward from the first part and the second part. The spacer assembly is arranged between a first photovoltaic tile and a second photovoltaic tile in a manner that a first end of the first photovoltaic tile is installed between the first groove and the first PL, and a first end of the second photovoltaic tile is installed between the second groove and the second PL.

### TECHNICAL FIELD

The present disclosure relates to spacer assemblies for water leakage prevention in photovoltaic tile arrangements.

### BACKGROUND

A growing use of solar energy has led to a significant increase in installations of photovoltaic tiles on rooftops of residential and commercial buildings. As the photovoltaic tiles are increasingly utilized for their functional benefits, ensuring their durability and performance in various environmental conditions becomes a critical concern during said installations. Typically, one of the major issues with rooftop installations of the photovoltaic tiles is water leakage because the water leakage can cause damage to a roof deck, and thus can compromise a structural integrity of the rooftop installations. Typically, the water leakage occurs at gaps between two consecutive photovoltaic tiles as such gaps provide potential entry points for water ingress, especially during heavy rainfall or photovoltaic tile cleaning operations.

Conventional techniques for preventing water leakage often involve application of sealants and creation of overlapping designs of photovoltaic tiles. However, said conventional techniques are associated with several drawbacks. Firstly, the sealants used for such purpose degrade over a period of time, especially, when exposed to a high temperature or due to frequent cleaning of the photovoltaic tiles. This leads to formation of gaps between photovoltaic tiles and subsequently results in water ingress. Secondly, the overlapping designs do not always form a tight seal, especially in areas where said photovoltaic tiles are subject to external environment factors, for example, such as high speed wind or thermal expansion due to heat; thus, do not prevent the water leakage effectively. Some existing techniques also employ waterproof membranes or gaskets to seal the gaps between the two consecutive solar glass tiles for preventing water penetration. However, all such solutions often fail to provide a long-term reliability for preventing water leakage under varying environmental conditions, for example, such as ultra-violet (UV) exposure, thermal cycling, heavy rainfall, and similar.

Therefore, in light of the foregoing discussion, there exists a need to overcome the aforementioned drawbacks.

### SUMMARY

The aim of the present disclosure is to provide a spacer assembly for water leakage prevention in a photovoltaic tile arrangement that ensures watertight sealing, facilitates an efficient water drainage through a water flow channel, and enhances structural integrity and durability of the photovoltaic tile arrangement under varying environmental conditions. The aim of the present disclosure is achieved by a spacer assembly for water leakage prevention in a photovoltaic tile arrangement, as defined in the appended independent claim to which reference is made to. Advantageous features are set out in the appended dependent claim.

In an aspect, an embodiment of the present disclosure provides a spacer assembly for water leakage prevention in a photovoltaic tile arrangement, the spacer assembly comprising:
an extruded aluminium profile comprising:
   a first part having a first groove and a first projecting lip;
   a second part having a second groove and a second projecting lip, wherein the second part is adjacent to the first part in a manner that a space between the first projecting lip and the second projecting lip forms a water flow channel;
   a third part that extends vertically downward from the first part and the second part, the third part having a pair of walls and a base that collectively form a hollow trapezoidal channel;
a first ethylene propylene diene monomer (EPDM) profile arranged in the first groove; and
a second EPDM profile arranged in the second groove,
wherein when the spacer assembly is in use, the spacer assembly is arranged between a first photovoltaic tile and a second photovoltaic tile in a manner that a first end of the first photovoltaic tile is installed between the first groove and the first projecting lip, and a first end of the second photovoltaic tile is installed between the second groove and the second projecting lip.

The present disclosure provides the aforementioned spacer assembly for water leakage prevention in the photovoltaic tile arrangement. Herein, an inclusion of the extruded aluminium profile ensures structural strength and durability of the spacer assembly, making it capable of withstanding various environmental stresses (for example, such as wind loads, thermal expansion, mechanical forces, and similar). This enhances an overall longevity and performance of the photovoltaic tile arrangement. Beneficially, a use of ethylene propylene diene monomer (EPDM) profile, arranged in grooves of the extruded aluminium profile, is highly resistant to water ingress, ultra-violet (UV) exposure, and temperature variations, thereby ensuring that a watertight seal is maintained between adjacent photovoltaic tiles even under extreme environmental conditions. A compression of the first EPDM profile and the second EPDM profile during the photovoltaic tile installation forms an effective barrier against water penetration, safeguarding an underlying roof deck from damage. Moreover, a design of the spacer assembly, including the first projecting lip and the second projecting lip forming the water flow channel, allows water to be efficiently directed away from the photovoltaic tile arrangement. This reduces a likelihood of water pooling or seepage at junctions of photovoltaic tiles. It will be appreciated that the hollow trapezoidal channel in the third part of the extruded aluminium profile reduces an overall weight of the spacer assembly without compromising its structural integrity, thereby facilitating an easier handling and installation of the photovoltaic tiles.

Throughout the description and claims of this specification, the words “comprise”, “include”, “have”, and “contain” and variations of these words, for example “comprising” and “comprises”, mean “including but not limited to”, and do not exclude other components, items, integers or steps not explicitly disclosed also to be present. Moreover, the singular encompasses the plural unless the context otherwise requires. In particular, where the indefinite article is used, the specification is to be understood as contemplating plurality as well as singularity, unless the context requires otherwise.

### BRIEF DESCRIPTION OF THE DRAWINGS

FIG. 1A is a schematic illustration of an exploded view of a spacer assembly for water leakage prevention in a photovoltaic tile arrangement, while and FIG. 1B is a cross-sectional view of said spacer assembly, in accordance with an embodiment of the present disclosure; and

FIGS. 2A and 2B illustrate a front view and a top perspective view of an installation of a spacer assembly for water leakage prevention in a photovoltaic tile arrangement, respectively, in accordance with an embodiment of the present disclosure.

### DETAILED DESCRIPTION

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

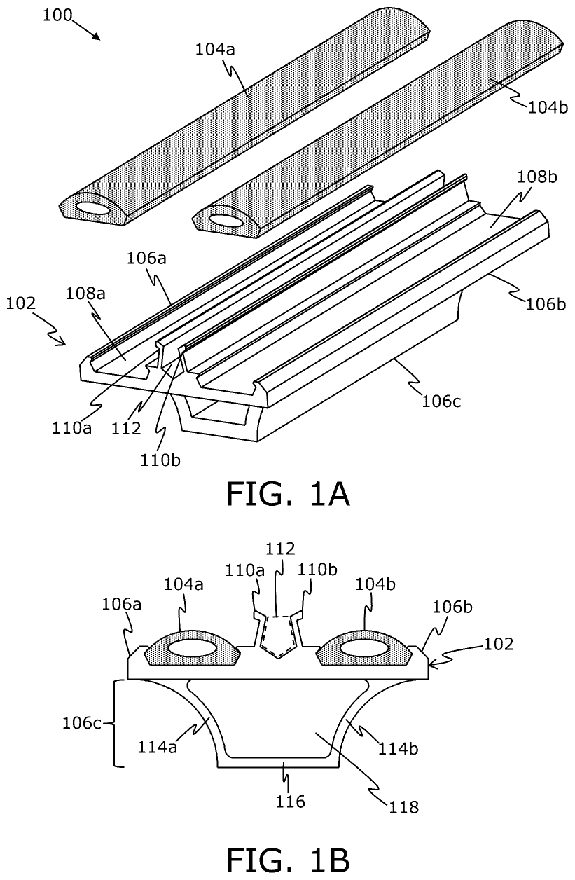

Referring to FIGS. 1A and 1B, FIG. 1A is a schematic illustration of an exploded view of a spacer assembly 100 for water leakage prevention in a photovoltaic tile arrangement, while FIG. 1B is a cross-sectional view of said spacer assembly 100, in accordance with an embodiment of the present disclosure. Since FIG. 1B represents the cross-sectional view, only some features of the spacer assembly 100 are visible in FIG. 1B.

With reference to FIGS. 1A and 1B, the spacer assembly 100 comprises an extruded aluminium profile 102, a first ethylene propylene diene monomer (EPDM) profile 104a (depicted using a dotted pattern), and a second EPDM profile 104b (depicted using a dotted pattern). The extruded aluminium profile 102 comprises: a first part 106a having a first groove 108a and a first projecting lip 110a; a second part 106b having a second groove 108b and a second projecting lip 110b, wherein the second part 106b is adjacent to the first part 106a in a manner that a space between the first projecting lip 110a and the second projecting lip 110b forms a water flow channel 112; and a third part 106c that extends vertically downward from the first part 106a and the second part 108b, the third part 106c having a pair of walls 114a and 114b and a base 116 that collectively form a hollow trapezoidal channel 118. For sake of clarity, features of the third part 106c have been shown comprehensively in FIG. 1B only. With reference to FIG. 1B, the first EPDM profile 104a is shown to be arranged in the first groove 108a and the second EPDM profile 104b is shown to be arranged in the second groove 108b. For sake of clarity, such arrangements have been shown only in FIG. 1B, as FIG. 1A depicts the exploded view of the spacer assembly 100.

Notably, when the spacer assembly 100 is in use, the spacer assembly 100 is arranged between a first photovoltaic tile (not shown in FIGS. 1A and 1B) and a second photovoltaic tile (not shown in FIGS. 1A and 1B) in a manner that a first end of the first photovoltaic tile is installed between the first groove 108a and the first projecting lip 110a, and a first end of the second photovoltaic tile is installed between the second groove 108b and the second projecting lip 110b.

FIG. 1A, and 1B, are merely examples, which should not unduly limit the scope of the claims herein. A person skilled in the art will recognize many variations, alternatives, and modifications of embodiments of the present disclosure.

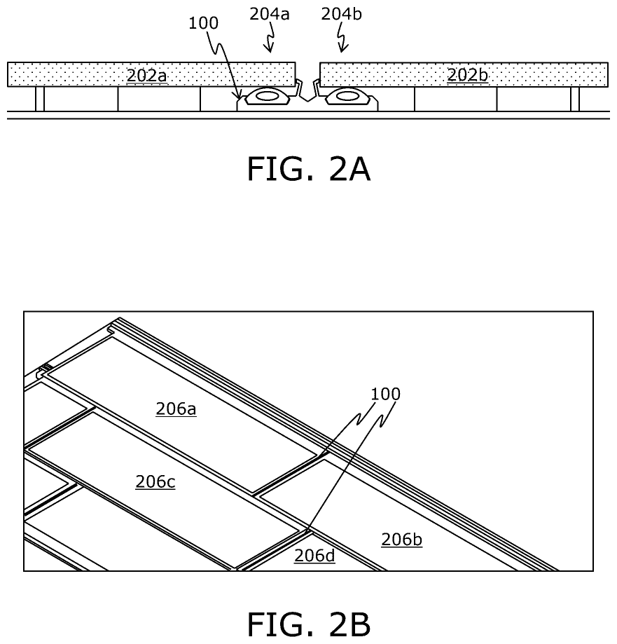

Referring to FIGS. 2A and 2B, illustrated are a front view and a top perspective view of an installation of the spacer assembly 100 for water leakage prevention in a photovoltaic tile arrangement, respectively, in accordance with an embodiment of the present disclosure.

With reference to FIG. 2A, the spacer assembly 100 is shown to be arranged (namely, installed) between a first photovoltaic tile 202a (depicted using a dotted pattern) and a second photovoltaic tile 202b (depicted using a dotted pattern) in a manner that a first end 204a of the first photovoltaic tile 202a is installed between the first groove 108a and the first projecting lip 110a, and a first end 204b of the second photovoltaic tile 202b is installed between the second groove 108b and the second projecting lip 110b.

With reference to FIG. 2B, the photovoltaic tile arrangement is shown to comprise a plurality of photovoltaic tiles (for sake of simplicity, some photovoltaic tiles are depicted as photovoltaic tiles 206a, 206b, 206c, and 206d), wherein the plurality of photovoltaic tiles 206a-d are arranged in an offset manner (namely, a staggered manner), and wherein for each pair of consecutive photovoltaic tiles (206a-b, 206c-d), a spacer assembly (such as the spacer assembly 100) is arranged therebetween for water leakage prevention. For sake of clarity, only a portion of the photovoltaic tile arrangement is shown FIG. 2B. It will be appreciated that the spacer assembly 100 is configured to maintain a consistent spacing and alignment between the plurality of photovoltaic tiles 206a-d, by accommodating the spacer assembly 100 in a tile channel groove (not shown) between a top row of photovoltaic tiles and a bottom row of photovoltaic tiles.

FIGS. 2A and 2B are merely examples, which should not unduly limit the scope of the claims herein. A person skilled in the art will recognize many variations, alternatives, and modifications of embodiments of the present disclosure.

The term “spacer assembly” refers to a structural component designed to be arranged between two adjacent photovoltaic tiles in a photovoltaic tile arrangement for preventing water leakage. The spacer assembly 100 serves several different functions, including maintaining a consistent spacing and an alignment between the photovoltaic tiles 202a-b, 206a-d, providing structural support, and forming a watertight seal to prevent water leakage.

The term “photovoltaic tile” refers to a structural and functional roofing element that integrates solar cells into its design, enabling it to generate electricity from sunlight while serving as a protective covering for a building's roof. Typically, the photovoltaic tiles 202a-b, 206a-d are made of durable materials (for example, such as tempered glass, polymers, composites, and similar) designed to withstand environmental stresses such as ultra-violet (UV) radiation, thermal expansion, and mechanical loads. The term “photovoltaic tile arrangement” refers to an assembly of the photovoltaic tiles 202a-b, 206a-d installed on a roof or a similar surface, where each photovoltaic tile integrates one or more photovoltaic cells to capture solar energy and convert it into electricity. The photovoltaic tiles 202a-b, 206a-d are aligned and secured in a patterned configuration to optimize energy generation while ensuring structural stability, weather resistance, and aesthetic integration with the building. It will be appreciated that the spacer assembly 100 for water leakage prevention in the photovoltaic tile arrangement provides a dual benefit of ensuring the structural stability of the photovoltaic tile configuration and effectively mitigating water ingress, especially in case of heavy rainfall or cleaning of the photovoltaic tiles 202a-b, 206a-d. This not only safeguards an underlying roof structure from potential water damage but also enhances overall durability and efficiency of the photovoltaic tile arrangement, especially under varying environmental conditions. It will also be appreciated that the spacer assembly 100 incorporates a streamlined design with a reduced number of components, which minimizes complexity and facilitates ease of installation. This simplifies assembly processes on-site, reducing installation time and associated labor costs. Furthermore, it will be appreciated that frictional engagement mechanism of the spacer assembly 100 eliminates the need for additional fasteners or adhesives, further enhancing the ease of installation and allowing for quick and secure placement of photovoltaic tiles 202a-b, 206a-d.

Optionally, the spacer assembly 100 is configured to maintain a consistent spacing and alignment between photovoltaic tiles 202a-b, 206a-d arranged in a staggered pattern, by accommodating the spacer assembly 100 in a tile channel groove between a top row of photovoltaic tiles 202a-b, 206a-d and a bottom row of photovoltaic tiles 202a-b, 206a-d. In this regard, the term “staggered pattern” refers to a layout or an arrangement in which the photovoltaic tiles 202a-b, 206a-d are positioned in a way that a location of each photovoltaic tile is offset or displaced relative to adjacent ones, in alternating rows or columns of the photovoltaic tiles 202a-b, 206a-d. Such an arrangement is commonly used to enhance overall structural stability, alignment, and aesthetic appearance. Herein, the staggered pattern helps to optimize the flow of water, thereby prevents direct alignment of seams between adjacent tiles, and improve overall durability of the photovoltaic tile arrangement by distributing mechanical stresses more evenly. Moreover, the term “tile channel groove” refers to a recessed feature or slot integrated into a supporting structure over which a given photovoltaic tile is arranged (namely, rests). The tile channel groove serves as a guiding and accommodating mechanism for arranging spacer assemblies (such as the spacer assembly 100) thereat, thereby reducing an overall installation time of the photovoltaic tile arrangement. In other words, the tile channel groove accommodates the spacer assembly 100, and the spacer assembly 100 fits snugly within it and enables in maintaining a necessary alignment between the top row of photovoltaic tiles 202a-b, 206a-d and the bottom row of photovoltaic tiles 202a-b, 206a-d. The tile channel groove may also ensure secure positioning and alignment of adjacent photovoltaic tiles, while also aiding in water flow management by directing water to flow away from critical areas of the photovoltaic tile arrangement via the water flow channel 112 of the spacer assembly 100.

A design of the spacer assembly 100 ensures that the photovoltaic tiles 202a-b, 206a d are uniformly spaced with respect to each other, i.e., having a correct offset with respect to each other to create the staggered pattern. This arrangement ensures that each tile is positioned correctly relative to the other, preserving the staggered pattern. The spacer assembly 100 also ensures that the gap between the photovoltaic tiles 202a-b, 206a-d remains consistent, which helps to prevent any misalignment during installation and ensures that the photovoltaic tiles 202a-b, 206a-d are properly spaced for an efficient water drainage and mechanical support. This eliminates a need for manual measurement during the photovoltaic tiles installation, and ensures a uniform spacing throughout the photovoltaic tiles installation.

Optionally, the spacer assembly 100 is held in position through a frictional engagement with the first photovoltaic tile 202a and the second photovoltaic tile 202b. In this regard, the frictional engagement occurs between two surfaces in contact namely, a top surface of a given EPDM profile 104a-b and a bottom surface of a given photovoltaic tile 202a-b, 206a-d where a force of friction between the two surfaces holds them together and prevents their relative movement. Herein, the term “given photovoltaic tile” encompasses the first photovoltaic tile 202a, the second photovoltaic tile 202b, and/or the plurality of photovoltaic tiles 206a-d. Thus, the frictional engagement occurs when the spacer assembly 100 is positioned between the first photovoltaic tile 202a and the second photovoltaic tile 202b, and contact surfaces of the spacer assembly 100 and said photovoltaic tiles 202a-b exert a resistance to movement, thus securely holding the spacer assembly 100 in place without requiring any external fasteners or adhesives (i.e., the spacer assembly 100 is not fixed or mounted on a roof deck). In other words, the spacer assembly 100 does not extend along an entire length of the photovoltaic tiles, instead, it is secured in a position beneath the photovoltaic tiles through the frictional engagement, even in presence of environmental forces such as high wind or thermal expansion due to heat. It will be appreciated that the spacer assembly 100 is designed to fit precisely between the first photovoltaic tile 202a and the second photovoltaic tile 202b in a manner that the top surface of the spacer assembly 100 engage with bottom surfaces of these photovoltaic tiles 202a-b. Moreover, a precise fit is maintained as the photovoltaic tiles 202a-b, 206a-d are pressed together during installation, and physical properties (for example, such as a surface texture, a material composition, and the like) of EPDM profiles 104a-b of the spacer assembly 100 ensures that the spacer assembly 100 remains securely in place throughout the installation. It will also be appreciated that due to the frictional engagement, a need for additional mounting or fixation elements is eliminated, thereby reducing a complexity and cost of installation of photovoltaic tiles 202a-b, 206a-d. A technical effect of the aforementioned feature is that it provides a simple, yet accurate and reliable way for securing the spacer assembly 100 in place, whilst reducing a complexity of the installation, thereby contributing to a long-term stability due to absence of external fasteners (which are prone to corrosion or degradation over time).

Optionally, the spacer assembly 100 is modular and designed for easy removal or replacement, without disassembling an entirety of the photovoltaic tile arrangement. In this regard, the spacer assembly 100 has components that can be removed or replaced easily as and when required. This may involve snap-fit connections of the spacer assembly with the tile channel groove that allow the spacer assembly 100 to be removed without disturbing the entirety of the photovoltaic tile arrangement. A modular design of the spacer assembly 100 may also allow for a tool-free installation or simple removal techniques to make the installation process faster and convenient. It will be appreciated that the modular design of the spacer assembly 100 provides an ease of maintenance, repair, or modification of the photovoltaic tile arrangement. Over time, certain parts of the photovoltaic tile arrangement, for example, such as the spacer assembly 100 may wear out, become damaged, or require a replacement. Thus, the modular design allows for quick replacement of only an affected part, thereby minimizing downtime and need for extensive labor. It is noteworthy that the spacer assembly 100 itself has less number of components, as compared to prior art where an installation of a given photovoltaic tile 202a-b, 206a-d needs an assembly having significant number of components. Thus, if any component of the spacer assembly 100 fails and requires replacement, it can be done easily and conveniently (i.e., without any complexity and difficulty), unlike the prior art. This is particularly important for large-scale photovoltaic installations where time and resources are critical. A technical effect is that the modular design allows for its quick and easy removal or replacement, reducing a maintenance time and reducing costs incurred in photovoltaic tile installations.

Optionally, the spacer assembly 100 is configured to allow for easy replacement or interchangeability of individual photovoltaic tiles 202a-b, 206a-d, without disassembling an entirety of the photovoltaic tile arrangement. In this regard, such a configuration of the spacer assembly 100 is achieved by designing said assembly in a way that components of the spacer assembly 100 support an independent removal and installation of the photovoltaic tiles 202a-b, 206a-d without requiring any disassembly of the entirety of the photovoltaic tile arrangement. For example, the spacer assembly 100 may incorporate features (for example, such as the first projecting lip 110a, the second projecting lip 110b, the first groove 108a, and the second groove 108b) that allows for snap fitting and easy removal of the photovoltaic tiles 202a-b, 206a-d such that they can be arranged securely in place but are also allowed to be swapped out when needed. Such a design ensures that the alignment and spacing of the photovoltaic tiles 202a-b, 206a-d are maintained, so that the photovoltaic tile arrangement remains functional even after individual tiles are replaced. It will be appreciated that this modularity enhances a long-term sustainability of photovoltaic tile arrangement by allowing damaged or degraded tiles to be replaced swiftly, thereby extending a service life of the installation and maintaining high performance throughout its lifecycle. A technical effect of the aforementioned feature is that this configuration allows for easy replacement or interchangeability of individual tiles enhancing overall flexibility, making photovoltaic tile installations highly convenient (and time-efficient) for maintenance and upgrades without requiring its full disassembly.

Throughout the present disclosure, the term “extruded aluminium profile” refers to a structural component manufactured through a well-known extrusion process, where aluminium alloy is forced through a die to create a continuous cross-sectional shape. The extruded aluminium profile 102 is designed to provide structural integrity, durability, and lightweight properties. Herein, the extruded aluminium profile 102 has specialized configurations, such as grooves 108a-b and projecting lips 110a-b, that enable precise alignment, water drainage, and secure interfacing with the photovoltaic tiles 202a-b, 206a-d. A technical effect of utilizing the extruded aluminium profile 102 is that it provides a robust and lightweight structure that ensures secure alignment of the photovoltaic tiles 202a-b, 206a-d, effective water drainage, and long-term durability. There will now be described various features of the extruded aluminium profile 102.

The term “groove” refers to a recessed or an indented channel formed along a surface of a given part of the extruded aluminium profile 102. The term “given part” encompasses the first part 106a and/or the second part 106b. Typically, a groove is designed to serve as a slot or guide for interfacing with other components. Particularly, in the spacer assembly 100, the first groove 108a and the second groove 108b in the extruded aluminium profile 102 are intended to accommodate parts of the photovoltaic tiles and/or an EPDM profile, providing a secure fit and preventing displacement or misalignment of these during installation. The term “projecting lip” refers to an extended edge or a flange that protrudes outward from a given part of the extruded aluminium profile 102. In the spacer assembly 100, the first projecting lip 110a and the second projecting lip 110b of the extruded aluminium profile 102 are positioned to assist in forming the water flow channel 112 while providing structural support and ensuring proper alignment of the photovoltaic tiles 202a-b, 206a-d. Herein, the term “water flow channel” refers to a specifically designed pathway or a conduit formed between the first projecting lip 110a and the second projecting lip 110b of the spacer assembly 100. The water flow channel 112 is intended to direct and facilitate the controlled movement of water, such as rainwater or condensation, away from critical components of the photovoltaic tile arrangement. The water flow channel 112 is designed to collect water that might otherwise accumulate near the photovoltaic tiles 202a-b, 206a-d, guiding it through a defined path to prevent entry into sensitive areas of the spacer assembly 100 or damage to the photovoltaic tiles 202a-b, 206a-d and underlying structure. It will be appreciated that the water flow channel 112 facilitates an effective drainage, reducing the risk of water ingress and enhancing the longevity of the photovoltaic tile installation. It will also be appreciated that a size of the water flow channel 112 is narrow enough (as compared to prior art) to minimize an ingress of debris, or other contaminants while being sufficiently wide to ensure an efficient drainage of water. The term “hollow trapezoidal channel” refers to a structural feature characterized by a hollow, an enclosed cross-section in the shape of a trapezoid, where the channel has two parallel sides (referred to as bases) and two non-parallel sides (referred to as legs). The hollow trapezoidal channel 118 is formed by a pair of walls 114a-b extending downward from a structural element and connected at the base 116, creating an internal cavity. In the spacer assembly 100, the hollow trapezoidal channel 118 of the third part 106c of the extruded aluminium profile 102 facilitates in reducing an overall weight of the spacer assembly 100 while maintaining its structural integrity. The hollow trapezoidal channel 118 may also provide additional functional advantages, for example, such as accommodating wiring, allowing airflow, enhancing mechanical strength, and similar. Hence, the precise alignment of grooves 108a-b, projecting lips 110a-b, and the hollow trapezoidal channel 118 ensures seamless interfacing with adjacent components while maintaining durability and functionality of the spacer assembly 100.

Optionally, the extruded aluminium profile 102 is coated with a corrosion-resistant material. Typically, the corrosion-resistant material is a substance or a coating applied to a surface that prevents or significantly reduces a rate of corrosion when exposed to environmental factors (for example, such as moisture, oxygen, salts, chemicals, or similar). The corrosion-resistant material functions by forming a protective barrier that isolates an underlying substrate from corrosive agents or by chemically stabilizing the surface to resist oxidation or other degradation processes. Examples of the corrosion-resistant material may include, but are not limited to, metallic coatings (such as zinc or anodized aluminium), polymeric coatings (such as powder coatings or epoxy-based finishes), chemical treatments (such as phosphate or chromate conversion coatings), and natural or synthetic paints with anti-corrosive properties. Herein, the corrosion-resistant material is applied to the extruded aluminium profile 102 through well-known methods, for example, such as a powder coating method, an anodization method, anti-corrosive paints, and the like. It will be appreciated that a protective barrier created by the corrosion-resistant material ensures compatibility with diverse environmental conditions, thereby extending the operational life of the spacer assembly 100 and contributing to the overall efficiency and cost-effectiveness of the photovoltaic tile arrangement. A technical effect of coating the extruded aluminium profile 102 with the corrosion-resistant material is that it improves a longevity and reliability of the spacer assembly 100, ensuring its resistance to environmental degradation.

Optionally, the hollow trapezoidal channel 118 of the third part 106c is designed to reduce an overall weight of the spacer assembly 100. In this regard, the hollow trapezoidal channel 118 is formed by the pair of walls 114a-b and the base 116 extending downward from the first part 106a and the second part 106b of the extruded aluminium profile 102. By incorporating a hollow design, the material used is minimized, and structural integrity is still maintained. The trapezoidal shape is effective because it provides strength and rigidity, ensuring that the spacer assembly 100 can support the photovoltaic tiles 202a-b, 206a-d while reducing unnecessary mass. It will be appreciated that minimizing material usage reduces the overall weight of the spacer assembly 100, making it easier to handle and install, especially in large photovoltaic tile installations. Using less material decreases production costs, making the spacer assembly 100 more economical to manufacture. A hollow design maintains a necessary structural integrity while optimising material usage, ensuring strength without unnecessary bulk. A technical effect is that the hollow trapezoidal channel 118 reduces the overall weight of the spacer assembly 100 while maintaining structural integrity. This results in easier handling, installation, and lower production costs, contributing to a more efficient and cost-effective design of the spacer assembly 100.

Throughout the present disclosure, the term “ethylene propylene diene monomer profile” refers to a specific form or shape of ethylene propylene diene monomer (EPDM) rubber, which is a synthetic elastomer made by polymerizing a mixture of ethylene, propylene, and a diene monomer. The EPDM profile is shaped or extruded into a specific cross-sectional design that allows it to serve as a gasket, seal, or cushioning element in various applications, such as in the photovoltaic tile arrangement. Beneficially, a given EPDM profile 104a-b has a high elasticity and UV resistance, thereby providing an improved durability under prolonged exposure to sunlight and environmental conditions. The EPDM profile may vary in shape (for example, such as round, square, custom-designed, and the like) depending on the specific sealing or cushioning function required in the design. Herein, the first EPDM profile 104a fits precisely into the first groove 108a and the second EPDM profile 104b fits into the second groove 108b within the extruded aluminium profile 102. These EPDM profiles 104a-b are specifically designed to ensure a tight, secure fit within the grooves 108a-b, providing a secure sealing effect. The flexible properties of EPDM allow said profiles to adapt to small movements or shifts in the photovoltaic tile arrangement while maintaining an effective seal over time.

Optionally, the first EPDM profile 104a and the second EPDM profile 104b are arranged in the first groove 108a and the second groove 108b using a metal-to-EPDM adhesive. In this regard, the term “metal-to-EPDM adhesive” refers to a specialized adhesive designed to bond metal surfaces, such as the extruded aluminium profile 102, to the given EPDM profile 104a-b. This type of adhesive is designed to effectively adhere to both metal and rubber materials, overcoming an inherent differences in surface properties. This adhesive can be in the form of a liquid, a paste, a tape, or similar, and is commonly used in applications where the durability of the bond is critical, such as in sealing, gasketing, and cushioning applications. Notably, a use of the metal-to-EPDM adhesive ensures a strong, durable bond between the profiles and grooves 108a-b, enhancing a stability and performance of the spacer assembly 100 in the photovoltaic tile arrangement. A technical effect of using the metal-to-EPDM adhesive is that it enhances the structural integrity of the spacer assembly 100, ensuring that the EPDM profiles 104a-b stay fixed in place within the grooves 108a-b of the extruded aluminium profile 102. This secure bonding prevents the profiles from shifting or detaching over time due to external forces, vibrations, or environmental factors such as weathering, moisture, UV exposure, and similar.

Optionally, the first EPDM profile 104a and the second EPDM profile 104b are designed to dampen noise caused by wind interactions and/or snowfall. In this regard, the EPDM is a material known for its excellent vibration damping properties and resilience to harsh weather conditions. The first EPDM profile 104a and the second EPDM profile 104b are designed with physical properties that allow them to act as a vibration absorber, effectively reducing a noise transmitted through the spacer assembly 100. When wind or snowfall interacts with the photovoltaic tiles 202a-b, 206a-d, vibrations and impacts are generated. The first EPDM profile 104a and the second EPDM profile 104b arranged in respective grooves 108a-b of the spacer assembly 100 absorb these vibrations, converting a kinetic energy into heat or dispersing it within a structure of the EPDM profiles 104a-b, thereby reducing overall noise/vibrations produced. A technical effect of such a design is that it significantly reduces noise/vibrations caused by an external environmental interactions, thereby preventing discomfort for users and improving the durability and functionality of the photovoltaic tile installation.

Throughout the present disclosure, the spacer assembly 100 is positioned between the first photovoltaic tile 202a and the second photovoltaic tile 202b. The first end 204a of the first photovoltaic tile 202a is arranged between the first groove 108a and the first projecting lip 110a of the extruded aluminium profile 102. This secures (one end of) the first photovoltaic tile 202a in place, aligning it properly with the spacer assembly 100. Similarly, the first end 204b of the second photovoltaic tile 202b is installed between the second groove 108b and the second projecting lip 110b of the extruded aluminium profile 102, ensuring a same secure positioning of (one end of) the second photovoltaic tile 202b at an opposite side of the spacer assembly 100. In this arrangement, the grooves 108a-b and projecting lips 110a-b serve as alignment guides that provide mechanical support to the photovoltaic tiles 202a-b, 206a-d and prevent them from slipping out of position. The EPDM profiles 104a-b (as discussed earlier) also help to protect the photovoltaic tiles 202a-b, 206a-d during installation, thereby reducing the risk of damage. A technical effect of such an arrangement is that it ensures a secure and stable placement of the photovoltaic tiles 202a-b, 206a-d within the spacer assembly 100 for water leakage prevention. By positioning the photovoltaic tiles 202a-b, 206a-d between the grooves 108a-b and projecting lips 110a-b, the spacer assembly 100 prevents displacement and misalignment, contributing to the overall structural integrity of the photovoltaic tile arrangement. It will be appreciated that this feature allows for quick, efficient, and secure installation of the photovoltaic tiles 202a-b, 206a-d without the need for additional fasteners or support structures. It will also be appreciated that this arrangement facilitates a uniform distribution of mechanical stress across the photovoltaic tiles 202a-b, 206a-d, enhancing the overall durability of the photovoltaic arrangement and reducing the risk of tile misalignment due to an environmental factors (like wind, vibration, or similar). The proper alignment and secure fitting of the photovoltaic tiles 202a-b, 206a-d lead to better performance, longer service life, and ease of maintenance for the photovoltaic tile installation. A technical effect is that it ensures a secure, moisture-resistant connection between the photovoltaic tiles 202a-b, 206a-d and the spacer assembly 100, thereby enhancing the structural integrity and durability of the photovoltaic tile arrangement while preventing the water ingress that could lead to damage or reduce performance of the photovoltaic tiles 202a-b, 206a-d.

Optionally, when the first photovoltaic tile 202a is installed between the first groove 108a and the first projecting lip 110a, the first EPDM profile 104a is compressed in the first groove 108a, thereby forming a watertight seal. In this regard, the term “watertight seal” refers to a joint, a connection, a barrier, or similar, formed between two or more surfaces that is designed to prevent the ingress of water under specified conditions. The watertight seal functions by maintaining its integrity under environmental conditions (such as pressure, temperature fluctuations, exposure to moisture, and similar) and is commonly used in applications where protection against water damage, corrosion, electrical short-circuiting, and the like is crucial. In an implementation, as the first photovoltaic tile 202a is installed, the first EPDM profile 104a, which is located in the first groove, is compressed against the first photovoltaic tile 202a and the extruded aluminium profile 102. The compression of material of the first EPDM profile 104a ensures that it fills any gaps or irregularities between two surfaces (i.e., between the first photovoltaic tile 202a and the extruded aluminium profile 102), thereby creating the watertight seal (i.e., for preventing water ingress). The EPDM material, known for its flexibility and durability, conforms to the surfaces it contacts, ensuring that any potential channels or voids between the components are sealed. This prevents moisture, rainwater, or other environmental elements from penetrating the joint, which is essential for maintaining the structural integrity and longevity of the photovoltaic tile arrangement. It will be appreciated that the compression of the first EPDM profile 104a ensures a consistent and reliable seal over time, even with potential thermal expansion or contraction of materials. A technical effect of the aforementioned feature is that it creates a reliable and durable watertight seal between the first photovoltaic tile 202a and the extruded aluminium profile 102, thereby ensuring protection from the water ingress.

Optionally, when the second photovoltaic tile 202b is installed between the second groove 108b and the second projecting lip 110b, the second EPDM profile 104b is compressed in the second groove 108b, thereby forming a watertight seal. In an implementation, as the second photovoltaic tile 202b is installed, the second EPDM profile 104b, which is located in the second groove, is compressed against the second photovoltaic tile 202b and the extruded aluminium profile 102. The compression of material of the second EPDM profile 104b ensures that it fills any gaps or irregularities between two surfaces (i.e., between the second photovoltaic tile 202b and the extruded aluminium profile 102), thereby creating the watertight seal. It will be appreciated that the compression of the second EPDM profile 104b ensures a consistent and reliable seal over time, even with potential thermal expansion or contraction of materials. A technical effect of the aforementioned feature is that it creates a reliable and durable watertight seal between the second photovoltaic tile 202b and the extruded aluminium profile 102, thereby ensuring protection from the water ingress.

What is claimed is:

1. A spacer assembly for water leakage prevention in a photovoltaic tile arrangement, the spacer assembly comprising:
an extruded aluminium profile comprising:
a first part having a first groove and a first projecting lip;
a second part having a second groove and a second projecting lip, wherein the second part is adjacent to the first part in a manner that a space between the first projecting lip and the second projecting lip forms a water flow channel;
a third part that extends vertically downward from the first part and the second part, the third part having a pair of walls and a base that collectively form a hollow trapezoidal channel;
a first ethylene propylene diene monomer (EPDM) profile arranged in the first groove; and
a second EPDM profile arranged in the second groove;
wherein when the spacer assembly is in use, the spacer assembly is arranged between a first photovoltaic tile and a second photovoltaic tile in a manner that a first end of the first photovoltaic tile is installed between the first groove and the first projecting lip, and a first end of the second photovoltaic tile is installed between the second groove and the second projecting lip.

2. The spacer assembly of claim 1, wherein when the first photovoltaic tile is installed between the first groove and the first projecting lip, the first EPDM profile is compressed in the first groove, thereby forming a watertight seal.

3. The spacer assembly of claim 1, wherein when the second photovoltaic tile is installed between the second groove and the second projecting lip, the second EPDM profile is compressed in the second groove, thereby forming a watertight seal.

4. The spacer assembly of claim 1, wherein the spacer assembly is configured to maintain a consistent spacing and alignment between photovoltaic tiles arranged in a staggered pattern, by accommodating the spacer assembly in a tile channel groove between a top row of photovoltaic tiles and a bottom row of photovoltaic tiles.

5. The spacer assembly of claim 1, wherein the hollow trapezoidal channel of the third part is designed to reduce an overall weight of the spacer assembly.

6. The spacer assembly of claim 1, wherein the spacer assembly is held in position through a frictional engagement with the first photovoltaic tile and the second photovoltaic tile.

7. The spacer assembly of claim 1, wherein the first EPDM profile and the second EPDM profile are arranged in the first groove and the second groove using a metal-to-EPDM adhesive.

8. The spacer assembly of claim 1, wherein the extruded aluminium profile is coated with a corrosion-resistant material.

9. The spacer assembly of claim 1, wherein the spacer assembly is modular and designed for easy removal or replacement, without disassembling an entirety of the photovoltaic tile arrangement.

10. The spacer assembly of claim 1, wherein the spacer assembly is configured to allow for easy replacement or interchangeability of individual photovoltaic tiles, without disassembling an entirety of the photovoltaic tile arrangement.

11. The spacer assembly of claim 1, wherein the first EPDM profile and the second EPDM profile are designed to dampen noise caused by wind interactions and/or snowfall.
